(19) United States
(12) Patent Application Publication
(10) Pub. No.: US 2013/0197121 A1
(43) Pub. Date: Aug. 1, 2013

(54) METHOD OF MAKING CROSSLINKED POLYMERIC MATERIAL FOR ORTHOPAEDIC IMPLANTS

(71) Applicants: Richard S. King, Warsaw, IN (US); Mark D. Hanes, Winona Lake, IN (US); Fu-wen Shen, Walnut, CA (US); Venkat Narayan, Fort Wayne, IN (US)

(72) Inventors: Richard S. King, Warsaw, IN (US); Mark D. Hanes, Winona Lake, IN (US); Fu-wen Shen, Walnut, CA (US); Venkat Narayan, Fort Wayne, IN (US)

(21) Appl. No.: 13/456,712

(22) Filed: Apr. 26, 2012

Related U.S. Application Data
(63) Continuation of application No. PCT/US10/54254, filed on Oct. 27, 2010.

(30) Foreign Application Priority Data
Oct. 27, 2010 (US) PCT/US10/54254

(51) Int. Cl. C08J 3/28

(52) U.S. Cl. CPC C08J 3/28
USPC 522/120; 522/127; 522/125

(57) ABSTRACT

A method for making a crosslinked polymeric material for use in an orthopaedic device is described. The method may include the use of one or more crosslinking enhancers to enhance the crosslinking process.

### CROSS-REFERENCE TO RELATED APPLICATIONS

This application claims priority to U.S. Provisional Application Ser. No. 61/256,029 filed on Oct. 29, 2009, the entire disclosure of which is hereby incorporated herein by reference.

### TECHNICAL FIELD

The present disclosure relates generally to a method of making a crosslinked polymeric material for use in orthopedic implants. In particular, this disclosure relates to a method of making crosslinked Ultra-High Molecular Weight Polyethylene for use in orthopaedic implants.

### BACKGROUND

In order for a polymeric material to be used in an orthopaedic application it must be biocompatible and tough enough to handle the loads imposed on the joint by normal living. Among other properties, it must also resist wear, mechanical damage, and have good lubricity. Various polymeric materials possess the aforementioned desirable characteristics which make them suitable for use in the construction of orthopaedic devices to be implanted in the body of an animal. For example, these polymers may be utilized in the construction of an articulating or bearing surface on which either a natural bone structure or a prosthetic component articulates. Specific examples of such polymeric bearing surfaces include acetabular bearings, glenoid bearings, tibial bearings, and the like, for use in hip, knee, shoulder, and elbow prostheses.

One example of such a polymer is crosslinked Ultra-High Molecular Weight Polyethylene (UHMWPE). This polymer is resistant to wear, fatigue, and fracturing which are characteristics that make it attractive for use in orthopaedic applications. Crosslinked UHMWPE is produced by exposing UHMWPE to a crosslinking process, such as irradiating the polymer with, for example, e-beam or gamma radiation. While radiation crosslinking of UHMWPE reduces its wear rate and particulate debris formation, it may also have a negative impact on its toughness and ductility. In addition, the radiation process increases both the production time and cost of manufacturing orthopaedic devices.

Accordingly, in light of the above discussion, it should be appreciated that a number of orthopaedic devices for implantation in the body of an animal are constructed from, or include components constructed from, a polymeric material. Therefore, it is desirable to enhance one or more characteristics of such a polymer and its method of production.

### SUMMARY

In accordance with the present disclosure, a crosslinked polymeric material for implanting in the body of an animal (e.g. a human) and a method for making the same, can comprise one or more of the features set forth below, or combinations thereof:

According to one aspect, UHMWPE is placed in contact with one or more crosslinking enhancers. The UHMWPE is then exposed to a crosslinking dose of radiation. For example the crosslinking dose of radiation can be from about 1 Mrad to about 50 Mrad. The crosslinking dose can also be from about 2.5 Mrad to about 25 Mrad. In addition, the crosslinking radiation can be from about 2.5 Mrad to about 15 Mrad. Furthermore, the crosslinking radiation can be from about 2.5 Mrad to about 10 Mrad. Moreover, the crosslinking dose can be from about 2.5 Mrad to about 4 Mrad. In addition, the radiation does can be from about 25 KGy to about 75 KGy (10 kGy=1 Mrad).

In addition it should be understood that the crosslinking radiation dose can be equal to the dose utilized to sterilize the UHMWPE. The sterilization and the crosslinking can also be performed simultaneously.

The crosslinking enhancer can include a number of compounds and mixtures thereof. Crosslinking enhances include vinyl esters and dithiols. Additional examples of crosslinking enhancers include at least one of the following, acrylic, methacrylic, ethacrylic, citraconic, maleic, malonic, mesaconic and ester and amide derivatives thereof. Moreover, the crosslinking enhancer can include at least one the following, hydroxyethyl methacrylate, allyl acrylate, allyl methacrylate, diallyl fumarate, ethylene glycol dimethacrylate, tetraethylene glycol dimethacrylate, butanedioldimethacrylate, 1,6-hexanediol dimethacrylate, 1,4-butylene glycol dimethacrylate, trimethylolpropane-trimethacrylate, pentaerythritol tetramethacrylate, tripropylene glycol diacrylate, neopentyl glycol diacrylate, tetraethylene glycol diacrylate, trimethylol propane triacrylate, trimethylol propane ethoxylate triacrylate, pentaerythritol tetraacrylate, diallyl phthalate, triallyl cyanurate, divinyl benzene, triallyl isocyanurate, diacetylene(2,4-hexadiyn-1,6-bis(n-butyl urethane), 2,4-hexadiyn-1,6-bis(ethyl urethane). If desired the crosslinking enhancer can be alone or in combination with any other crosslinking enhancer.

Additional example of crosslinking enhancers include dienes having the formula H₂C═CH—(CH₂)ₙ—CH═CH₂ where n is from 10 to 26. For example, 1,9-decadiene, 1.15-hexadecadiene, 1,17-octadecadiene.

Crosslinking enhancers also include compounds having the formula

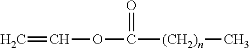

where n is from 2 to 26. Crosslinking enhancers can include vinyl caprylate, pelargonate, caprate, myristate, palmitate, stearate. Furthermore, a crosslinking enhancer can include one vinyl ester having one or more non-terminal double bonds. Crosslinking enhancers can include one of the following, vinyl 10-hendecenoate and vinyl oleate.

Further illustrative examples of crosslinking enhancers include compounds having the formula

HS—(CH₂)ₙ—SH

where n is from 6 to 30. Moreover, crosslinking enhancers include 1,6-hexanedithiol, 1,7-heptanedithiol, 1,8-octanedithiol, 1,9-nonanedithiol, 1,10-decanedithiol, 1,11-undecanedithiol, 1,12-dodecanedithiol, 1,13-tridecanedithiol, 1,14-tetradecanedithiol, 1,15-pentadecanedithiol, 1,16-hexadecanedithiol, 1,17-heptadecanedithiol, 1,18-octadecanedithiol, 1,19-nonadecanedithiol, 1,20-eicosanedithiol 1,21-heneicosanedithiol, 1,22-docosanedithiol, 1,23-tricosanedithiol, 1,24-tetracosanedithiol, 1,25-pentacosanedithiol, 1,26-hexacosanedithiol, 1,27-heptacosanedithiol, 1,28-octacosanedithiol, 1,29-nonacosanedithiol.

It should be appreciated that the crosslinked UHMWPE can be used in, for example, knee, hip, elbow, and shoulder orthopaedic implants.

Additional features of the present disclosure will become apparent to those skilled in the art upon consideration of the following detailed description of preferred embodiments exemplifying the best mode of carrying out the subject matter of the disclosure as presently perceived.

### BRIEF DESCRIPTION OF THE DRAWINGS

The detailed description particularly refers to the accompanying figure in which:

FIG. 1A-E shows a flow chart of exemplary pathways for using crosslinking enhancers in processing UHMWPE.

### DETAILED DESCRIPTION

While the concepts of the present disclosure are susceptible to various modifications and alternative forms, specific exemplary embodiments thereof will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

The orthopaedics industry utilizes radiation crosslinking to improve the wear resistance and reduce the particulate debris formation characteristics of UHMWPE. To a degree, the desirable characteristics radiation imparts upon UHMWPE is dose dependent. For example, increasing the radiation dose results in a greater degree of crosslinking, and accordingly, increases the wear resistance of UHMWPE and decreases particulate debris formation. However, increasing the irradiation of UHMWPE also has draw backs. For example, increased irradiation of this material can reduce its toughness and ductility. One or more of the undesirable characteristic associated with higher radiation doses may be caused by (i) a greater degree of point-to-point covalent bond formation (i.e. covalent bond formation between free radicals of adjacent intra or inter polymer chains) and (ii) undesirable chain scissions. Furthermore, increasing the radiation dose requires longer irradiation/exposure time which increases both production cost of crosslinked UHMWPE and the time it takes to make the same.

Accordingly, the ability to use lower doses of radiation for crosslinking UHMWPE while still achieving the aforementioned advantageous characteristics associated with higher doses of radiation is desirable. In light of the above, the present disclosure is directed to an enhanced method of making crosslinked UHMWPE for use in orthopaedic implants, such as knee, hip, elbow, and shoulder orthopaedic implants.

For example, the present disclosure is directed to utilizing a crosslinking enhancer to enhance one or more of the following (i) the degree of crosslinking by a relatively low dose of radiation, (ii) the reduction of polymer chain scissions during the irradiation process, (iii) the modification of crosslinking morphology by decreasing the amount of point-to-point covalent bond formation while increasing bridge type covalent bond formation, and (iv) the reduction of post-radiation residual free radicals. Note that one example of a bridge type covalent bond formation is one that is formed by inserting one or more reactive functional monomers between two polymer chains. As indicated, the insertion of one or more substituted ethylene moieties between two polymer chains results in the formation of a bridge type covalent bond (e.g. vinyl ester compounds). An example for dithiol crosslinkers, is one that the covalent bond is formed by inserting one disulfide compound between two polymer chains.

In one embodiment, one or more crosslinking enhancers are utilized to enhance the crosslinking of UHMWPE. One advantage of using crosslinking enhancers is that these compounds improve crosslinking of UHMWPE with the use of a relatively low dose of radiation (note that the radiation crosslinking can be performed under vacuum or inert atmosphere). In particular, by using a crosslinking enhancer a desired degree of UHMWPE crosslinking can be achieved using a relatively low dose of radiation as compared to the radiation dose required for substantially the same degree of crosslinking in the absence of a crosslinking enhancer. For example, if a combination of a crosslinking enhancer and an antioxidant is present during the processing of UHMWPE a lower dose of radiation is required to obtain the targeted degree of crosslinking as compared to when there is no crosslinking enhancer present. Examples of antioxidants include both natural and synthetic antioxidants. Particular examples of antioxidants include, tocopherols and their derivatives, ascorbic acid and its ester derivatives, tetrakis[3-(3,5-di-tert-butyl-4-hydroxyphenyl)propionate], octadecyl ester of 3,5-bis(1,1-dimethylethyl)-4-hydroxy-benzenepropanoic acid, octyl ester of 3,5-di-tert-butyl-4-hydroxyhydrocinnamic acid. In short, the methods described herein can enhance crosslinking and thus allow a lower radiation dose to be used.

As indicated above, it should be appreciated that a lower radiation dose is advantageous because, among other things, it can reduce production cost, saves time (quick turnaround), is simpler, more efficient, and reduces polymer chain scissions. In addition, it should be understood that the use of a crosslinking enhancer can enhance the distribution uniformity of crosslinking as compared to when irradiation takes place when no crosslinking enhancer is present. An enhanced distribution uniformity can improve the wear resistance and other mechanical properties of crosslinked UHMWPE.

In some instances, the methods described herein can result in utilizing half the radiation dose as compared to traditional radiation crosslinking methods. Examples of radiation doses that can be used in the described methods range from about 1 to about 50 Mrad. In addition, the range can be from about 2.5 to about 25 Mrad. Moreover, the range can be from about 2.5 to about 15 Mrad. Furthermore, the range can be from about 2.5 to about 10 Mrad. Additional radiation doses, include from about 25 KGy to about 75 KGy.

It should be appreciated that a standard sterilization radiation dose used in the orthopaedics industry is from about 2.5 Mrad to about 4 Mrad. Accordingly, the methods described herein allow increased crosslinking at standard sterilization radiation doses. In addition, it should be appreciated that since the standard sterilization dose is from about 2.5 Mrad to about 4 Mrad, UHMWPE can be crosslinked to a targeted degree of crosslinking and sterilized simultaneously.

Crosslinking enhancers can be added to UHMWPE prior to exposure to crosslinking radiation in any way deemed appropriate by one of ordinary skill in the art. For example, a crosslinking enhancer can be added to UHMWPE by high shear mixing, surface coating or an in-fusion process. An exemplary amount of a crosslinking enhancer added to UHMWPE prior crosslinking can be from about 0.01% to about 5% (wt %). In addition, the amount can be from about 0.05% to about 4% (wt %). Moreover, the amount can be from about 0.05% to about 2.5% (wt %).

The types of compounds that can be used as crosslinking enhancers include, for example, compounds that increase radiation crosslinking and/or reduce chain scission. These compounds include, for example, reactive functional monomers. Reactive functional monomers include those which are bi-, tri-, and tetra-functional, being ethylenically unsaturated. The reactive functional monomers include carboxyl containing monomers such as acrylic, methacrylic, ethacrylic, citraconic, maleic, malonic, mesaconic and derivates thereof, including ester and amide derivatives. As such, reactive functional monomers include compounds such as hydroxyethyl methacrylate, allyl acrylate, allyl methacrylate, diallyl fumarate, ethylene glycol dimethacrylate, tetraethylene glycol dimethacrylate, butanedioldimethacrylate, 1,6-hexanediol dimethacrylate, 1,4-butylene glycol dimethacrylate, trimethylolpropane-trimethacrylate, pentaerythritol tetramethacrylate, tripropylene glycol diacrylate, neopentyl glycol diacrylate, tetraethylene glycol diacrylate, trimethylol propane triacrylate, trimethylol propane ethoxylate triacrylate, pentaerythritol tetraacrylate, diallyl phthalate, and the like. Reactive functional monomers also include compounds such as triallyl cyanurate, divinyl benzene, triallyl isocyanurate, diacetylene(2,4-hexadiyn-1,6-bis(n-butyl urethane), and 2,4-hexadiyn-1,6-bis(ethyl urethane).

Additional exemplary compounds which can be used as crosslinking enhancers are set forth below. First, note that some of the physical/chemical characteristics of compounds that can be utilized as crosslinking enhancers include being substantially non-volatile solids or liquids having a boiling point of greater than about 175° C., and exhibit a polarity which does not provide a significant obstacle to their even disposition within a UHMWPE matrix. Such compounds include C₆-C₃₀ chain compounds (e.g. straight chain compounds) which may contain two or more double bonds which may be located at a terminal position. These compounds can also have two terminal thiol groups. Examples of vinyl esters of fatty acids, and mercapto compounds are set forth below.

Additional example of crosslinking enhancers include compounds having the formula H₂C═CH—(CH₂)ₙ—CH═CH₂ where n is from 10 to 26. For example, 1,9-decadiene, 1.15-hexadecadiene, 1,17-octadecadiene.

Representative vinyl esters of fatty acids which can be used as crosslinking enhancers include compounds having the formula:

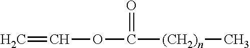

where n is an integer from 2 to 26. Examples of such vinyl esters of fatty acids include vinyl caprylate, pelargonate, caprate, myristate, palmitate, and stearate, as well as such vinyl esters having one or more additional non-terminal double bonds, such as vinyl 10-hendecenoate (undecylenate) vinyl oleate, and mixtures thereof. Vinyl cinnamate and allyl benzyl ethers can also be utilized.

Representative crosslinking enhancer mercapto compounds include dithiol compounds of the formula:

HS—(CH₂)ₙ—SH

where n is an integer between 6 and 30. These crosslinking enhancers include 1,6-hexanedithiol, 1,7-heptanedithiol, 1,8-octanedithiol, 1,9-nonanedithiol, 1,10-decanedithiol, 1,11-undecanedithiol, 1,12-dodecanedithiol, 1,13-tridecanedithiol, 1,14-tetradecanedithiol, 1,15-pentadecanedithiol, 1,16-hexadecanedithiol, 1,17-heptadecanedithiol, 1,18-octadecanedithiol, 1,19-nonadecanedithiol, 1,20-eicosanedithiol, 1,21-heneicosanedithiol, 1,22-docosanedithiol, 1,23-tricosanedithiol, 1,24-tetracosanedithiol, 1,25-pentacosanedithiol, 1,26-hexacosanedithiol, 1,27-heptacosanedithiol, 1,28-octacosanedithiol, and 1,29-nonacosanedithiol, and mixtures thereof.

Another aspect of the present invention is that the irradiated crosslinking enhancer-containing UHMWPE is thermally treated to reduce residual free radicals and improve its resistance to oxidation. Examples of thermal treatments are melting and annealing. The term “melting” means that the irradiated UHMWPE is heated above its peak melting temperature, whereas the term “annealing” means that the irradiated UHMWPE is heated below its peak melting temperature. The peak melting temperature of the irradiated UHMWPE is identified from the peak of the melting endotherm as measured by differential scanning calorimeter. Preferably, the temperature for melting the irradiated UHMWPE is from the peak melting temperature of the irradiated UHMWPE to about 100° C. to 160° C. above the peak melting temperature of the irradiated UHMWPE; more preferably from about 40° C. to 80° C. above the peak melting temperature of the irradiated UHMWPE; and most preferably from about 1° C. to about 60° C. above the peak melting temperature of the irradiated UHMWPE. The irradiated UHMWPE is preferably melted over a period from about 1 hour to about 3 days, more preferably from about 1 hour to about 2 days, and most preferably from about 2 hours to about 1 day. The temperature for annealing the irradiated UHMWPE is preferably from about room temperature to about 1° C. below the peak melting temperature of the irradiated UHMWPE; more preferably from about 90° C. to about 1° C. below the peak melting temperature of the irradiated UHMWPE; and most preferably from about 70° C. to about 1° C. below the peak melting temperature of the irradiated UHMWPE. The time for annealing is preferably from about 2 hours to about 7 days, and more preferably from about 7 hours to about 5 days, and more preferably from about 10 hours to about 2 days.

Another aspect of the present invention is that for the antioxidant and crosslinking enhancer-containing UHMWPE, there is no need to thermally treat the irradiated UHMWPE after crosslinking because the presence of antioxidant renders the irradiated UHMWPE oxidation resistant. One advantage of this invention is that the crosslinking and sterilization of UHMWPE by irradiation can be done simultaneously.

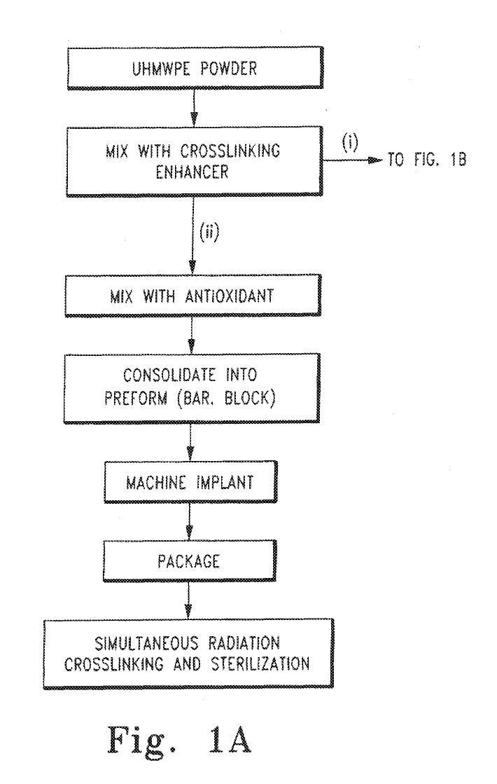

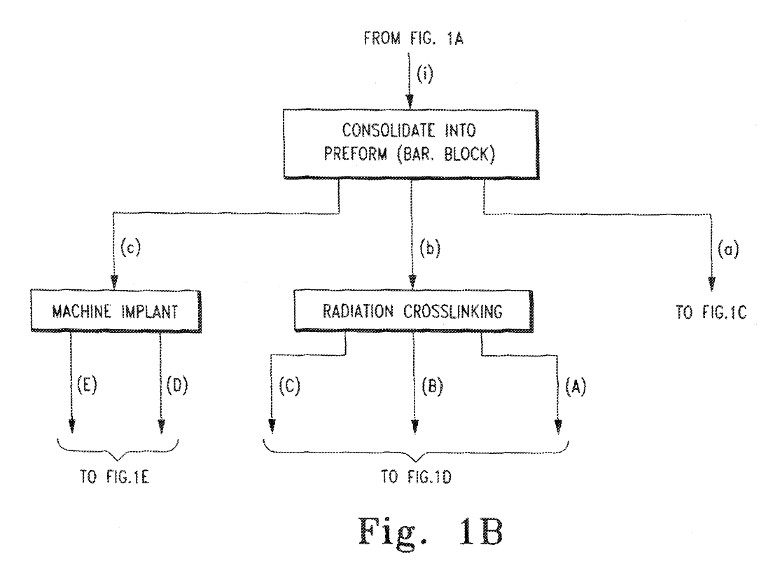

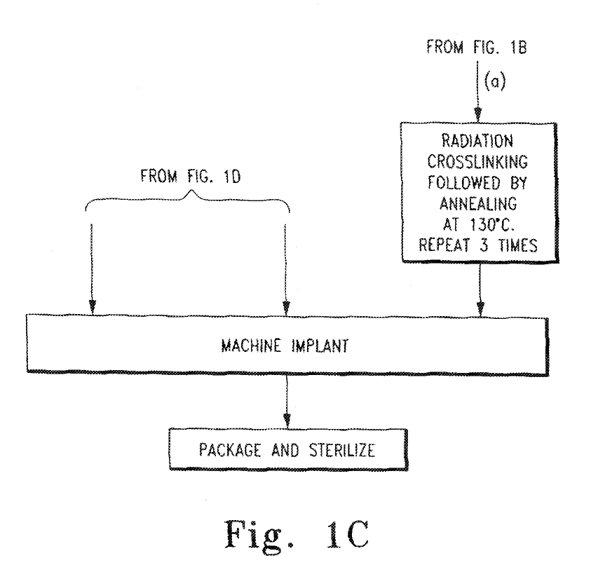

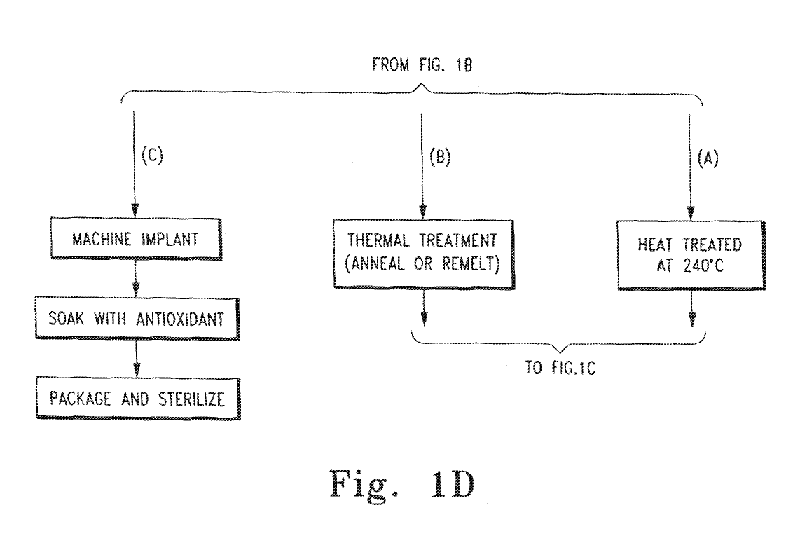

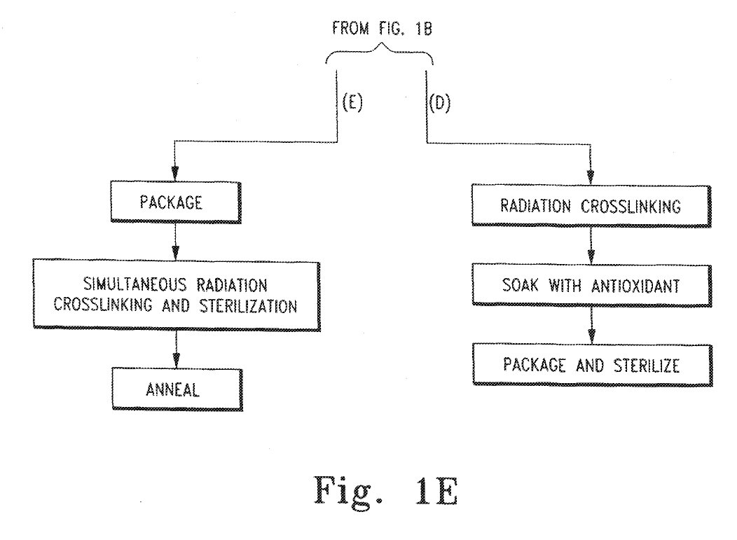

Now turning to the processing of UHMWPE utilizing a crosslinking enhancer. FIG. 1A-E illustrates a flow chart showing a number of exemplary process pathways for using crosslinking enhancers in processing UHMWPE. FIG. 1A shows that one or more crosslinking enhancers can be mixed with UHMWPE powder. Once done, two optional process pathways are available, (i) consolidation into a preform (bar or block; see FIG. 1B) or (ii) mixing with an antioxidant. If mixing UHMWPE with an antioxidant pathway is selected, then the UHMWPE is consolidated into a preform, machined, packaged and simultaneously crosslinked and sterilized via exposure to an appropriate dose of radiation.

If the consolidation pathway is selected, (pathway (i); from FIG. 1A to FIG. 1B), then three additional pathways are available for processing the UHMWPE (see FIG. 1B). These being (a) radiation crosslinking and annealing at 130° C. (the radiation crosslinking and annealing being repeated 3 times; see FIG. 1C), (b) radiation crosslinking, and (c) machining the implant. As shown in FIG. 1C, if pathway (a) is selected, i.e. the crosslinking and annealing pathway, it is followed by machining, packaging, and sterilization.

If pathway (b) is selected, i.e. the radiation crosslinking pathway, then three additional processing pathways are available from that point. The first being, (A) heat treating at 240° C., machining, packaging, and sterilization (see FIG. 1D to FIG. 1C). The second being, (B) thermal treatment (annealing or melt), machining, packaging and sterilization (see FIG. 1D to FIG. 1C). The third being, (C) machining, soaking with an antioxidant, packaging, and sterilization (see FIG. 1D).

If pathway (c) (see FIG. 1B), i.e. machining the implant, is selected from the consolidation point then two additional pathways are available. The first being (D) radiation crosslinking, soaking with an antioxidant, packaging, and sterilization (see FIG. 1E). The second being (E) packaging, simultaneous radiation crosslinking and sterilization, and then annealing (see FIG. 1E).

Which pathway to take for processing UHMWPE in the presence of a crosslinking enhancer can be determined by one of ordinary skill in the art based upon a number of parameters, e.g. the type of application the crosslinked UHMWPE will be used in, the chemical and mechanical attributes desired, and efficiency of a particular pathway in light of the targeted degree of crosslinking.

Specific examples of methods utilizing the compounds discussed above to process UHMWPE are set forth below:

### EXAMPLE (1)

Preparation of 1,16-hexadecanedithiol/ethyl alcohol solution→Coating GUR 1020 powder with the solution→Drying→Ram extrusion→Gamma irradiation at 50 kGy→Melting the crosslinked GUR 1020→Machining component→Tyvek packaging→Gas plasma sterilization

### EXAMPLE (2)

Preparation of tetrakis[3-(3,5-di-tert-butyl-4-hydroxyphenyl)propionate] and dimethyl maleate solution→Coating GUR 1020 powder with the solution→Drying→Compression molding→Machining components→Vacuum foil packaging→Gamma sterilization/crosslinking at 75 kGy

### EXAMPLE (3)

High-shear blending of ethyl undecylenate with GUR 1050 powder→Compression molding→Machining components→Vacuum foil packaging→Gamma radiation sterilization/crosslinking→Annealing

### EXAMPLE (4)

Preparation of acetone solution of α-tocopherol and 1,17-octadecadiene→Coating GUR 1020 powder with solution→Drying→Compressions molding→Machining components→Vacuum foil packaging→simultaneous sterilization/crosslinking with Gama radiation

### EXAMPLE (5)

GUR 1020 powder→Ram extrusion→Machining component→Infusing vinyl stearate at 120° C.→Vacuum foil packaging→Gamma radiation crosslinking→Annealing

After processing the UHMWPE utilizing the procedures described herein, the properties of irradiated UHMWPE, for example, degree of crystallinity, level of crosslinking (i.e., swell ratio and gel content), tensile properties and impact strength, resistance to oxidation and wear, can be determined using methods known in the art, e.g., methods described in U.S. Pat. No. 6,228,900. An alternative method for determining the swell ratio of irradiated UHMWPE is described in ASTM F 2214-02.

While the disclosure has been illustrated and described in detail in the foregoing description, such description is to be considered as exemplary and not restrictive in character, it being understood that only illustrative embodiments have been described and that all changes and modifications that come within the spirit of the disclosure are desired to be protected.

There are a plurality of advantages of the present disclosure arising from the various features of the materials and methods of making the materials described herein. It will be noted that alternative embodiments of the materials and methods of the present disclosure may not include all of the features described yet still benefit from at least some of the advantages of such features. Those of ordinary skill in the art may readily devise their own implementations of the materials and methods that incorporate one or more of the features of the present invention and fall within the spirit and scope of the present disclosure as defined by the appended claims.

What is claimed is:

1. A method of making crosslinked UHMWPE, comprising:
contacting UHMWPE with a crosslinking enhancer; and crosslinking the UHMWPE by exposing the UHMWPE to a radiation dose from about 1 Mrad to about 50 Mrad.

2. The method of claim 1, wherein:
the crosslinking enhancer includes at least one of the following, acrylic, methacrylic, ethacrylic, citraconic, maleic, malonic, mesaconic acids and ester and amide derivatives thereof.

3. The method of claim 1, wherein:
the crosslinking enhancer includes at least one of the following, hydroxyethyl methacrylate, allyl acrylate, allyl methacrylate, diallyl fumarate, ethylene glycol dimethacrylate, tetraethylene glycol dimethacrylate, butanedioldimethacrylate, 1,6-hexanediol dimethacrylate, 1,4-butylene glycol dimethacrylate, trimethylolpropane-trimethacrylate, pentaerythritol tetramethacrylate, tripropylene glycol diacrylate, neopentyl glycol diacrylate, tetraethylene glycol diacrylate, trimethylol propane triacrylate, trimethylol propane ethoxylate triacrylate, pentaerythritol tetraacrylate, diallyl phthalate, triallyl cyanurate, divinyl benzene, triallyl isocyanurate, diacetylene(2,4-hexadiyn-1,6-bis(n-butyl urethane), 2,4-hexadiyn-1,6-bis(ethyl urethane).

4. The method of claim 1, wherein:
the crosslinking enhancer includes a compound having the formula
H₂C═CH—(CH₂)ₙ—CH═CH₂
wherein n is from 10 to 26.

5. The method of claim 1, wherein:
the crosslinking enhancer includes a compound having the formula 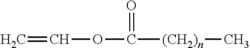
wherein n is from 2 to 26.

6. The method of claim 1, wherein:
the crosslinking enhancer includes at least one vinyl ester having one or more non-terminal double bond.

7. The method of claim 1, wherein:
the crosslinking enhancer includes a compound having the formula
HS—(CH₂)ₙ—SH
wherein n is from 6 to 30.

8. The method of claim 7, wherein:
the crosslinking enhancer includes at least one of the following, 1,6-hexanedithiol, 1,7-heptanedithiol, 1,8-octanedithiol, 1,9-nonanedithiol, 1,10-decanedithiol, 1,11-undecanedithiol, 1,12-dodecanedithiol, 1,13-tridecanedithiol, 1,14-tetradecanedithiol, 1,15-pentadecanedithiol, 1,16-hexadecanedithiol, 1,17-heptadecanedithiol, 1,18-octadecanedithiol, 1,19-nonadecanedithiol, 1,20-eicosanedithiol, 1,21-heneicosanedithiol, 1,22-docosanedithiol, 1,23-tricosanedithiol, 1,24-tetracosanedithiol, 1,25-pentaeosanedithiol, 1,26-hexacosanedithiol, 1,27-heptacosanedithiol, 1,28-octacosanedithiol, and 1,29-nonacosanedithiol.

9. The method of claim 1, further comprising:
contacting the UHMWPE with an antioxidant.

10. The method of claim 9, wherein:
the antioxidant includes at least one of the following, tocopherols and derivatives thereof, ascorbic acid and esters thereof, tetrakis[3-(3,5-di-tert-butyl-4-hydroxyphenyl)propionate], octadecyl ester of 3,5-bis(1,1-dimethylethyl)-4-hydroxy-benzenepropanoic acid, octyl ester of 3,5-di-tert-butyl-4-hydroxyhydrocinnamic acid.
